(19) United States
(12) Patent Application Publication
(10) Pub. No.: US 2024/0241482 A1
(43) Pub. Date: Jul. 18, 2024

(54) COMPUTER-IMPLEMENTED METHOD AND SYSTEM FOR DETERMINING OPTIMIZED SYSTEM PARAMETERS OF A TECHNICAL SYSTEM BY MEANS OF A COST FUNCTION

(71) Applicant: Continental Automotive Technologies GmbH, Hannover (DE)

(72) Inventors: Christian Wirth, Niederhöchstadt (DE); Jörg Dietrich, Mainz (DE)

(73) Assignee: Continental Automotive Technologies GmbH, Hannover (DE)

(21) Appl. No.: 18/562,290

(22) PCT Filed: May 19, 2022
(86) PCT No.: PCT/DE2022/200102

§ 371 Date: Nov. 18, 2023

(30) Foreign Application Priority Data
May 19, 2021 (DE) 10 2021 205 098.0

(51) Int. Cl. G05B 13/02; G06F 17/17

(52) U.S. Cl. CPC G05B 13/024; G06F 17/17

(57) ABSTRACT

A method for determining optimized system parameters of a technical system using a cost function. The cost function is provided for determining optimized system parameters of the technical system. The technical system has system parameter-adjustable components. When the system parameters are set, the technical system generates component output values. The method includes:
providing historical system parameters and component output values,
providing technical system rules based on the system parameters and their output values,
determining a function space corresponding to a function set wherein the cost function lies,
generating probability functions from the historical system parameters and corresponding output values using a rule, wherein each probability function indicates the probability which satisfies the rule by any cost function,
combining probability functions to determine the cost function by maximizing overall probability of all rules,
optimizing the system parameters given the cost function, and
outputting the optimized system parameters to adjust the components.

### CROSS-REFERENCE TO RELATED APPLICATIONS

The present application is a National Stage Application under 35 U.S.C. § 371 of International Patent Application No. PCT/DE2022/200102 filed on May 19, 2022, and claims priority from German Patent Application No. 10 2021 205 098.0 filed on May 19, 2021, in the German Patent and Trademark Office, the disclosures of which are herein incorporated by reference in their entireties.

### TECHNICAL FIELD

The invention relates to a computer-implemented method for determining a cost function, wherein the cost function is provided for the purpose of determining optimized system parameters of a technical system, wherein the technical system has different components that may be adjusted by the system parameters, and wherein, when the system parameters are set, the technical system generates different output values for the different components. Ultimately, optimized system parameters of the technical system are determined using the cost function. The invention further relates to a computer system.

### BACKGROUND

Complex technical systems (or installations) have many components that must be adjusted with system parameters. In practice, determining the parameters poses great difficulties.

These problems are called parameterization problems and are generally problems in which the technical system has freely selectable parameters that influence the system behavior, whereby the system behavior is subject to evaluation.

Approximation methods or algorithms can be used to determine suitable parameters.

Those problems in which the parameters represent free variables and a so-called cost function, which represents an evaluation function, is intended to be optimized are considered to be an optimization problem. This cost function describes the quality of the selected parameters and is evaluated by testing the effect of the parameters using the system. In most cases, there is also no cost function because the physical system provides a plurality of output values and the output values cannot be directly interpreted as costs (or benefits). This means that the expected quality is not directly one of the (numerical) output values. The output of the system then forms the input of the cost function, with the cost function being implicitly determined by the system or by experts. This means that the system has output values that can be used to represent the quality of the system. For example, it is known which output values can be considered good and a corresponding function can therefore be defined.

Furthermore, system parameters usually have to be determined individually for each parameterization problem using experts and expert knowledge, with a change in the model or minor changes to the technical system making complex new determinations necessary. However, cost functions determined by experts require a clear, reliable definition that enables automatic evaluation. This is usually not possible due to only abstract expert knowledge.

In particular, the consideration of which output values should have how much influence on the cost function is often impossible to decide precisely and is often subject to expert experience or expert intuition. In addition, the expert must ensure that all relevant influences are correctly taken into account.

Therefore, in practice, determining a cost function is an iterative process in which the expert considers the optimized system parameters to further adjust the cost function until the result meets their expectations. However, this is costly and time-consuming.

Furthermore, the cost function must be adapted to specific customer requirements, which in turn requires a corresponding expert process.

WO 2001 061 573 A2 discloses a method for calculating a model of a technical system that has a functional structure with functions and at least one undetermined parameter, having the steps of: querying the functional structure of the model; querying a data file; creating an optimization environment for calculating the parameters of the model; generating starting values for the at least one undetermined parameter from the functional structure; and calculating and outputting the parameters.

### SUMMARY

It is therefore an object of the present disclosure to specify a computer-implemented method for the essentially automated determination of optimized system parameters of a technical system using a cost function, wherein the cost function is provided for the purpose of determining optimized system parameters of the technical system. Another object is also to specify a correspondingly configured computer system.

The object is addressed by a computer-implemented method having the features of claim 1 and a computer system having the features of claim 8.

The subclaims relate to advantageous embodiments and developments which may be used individually or in combination with one another.

The object is addressed by a computer-implemented method for determining optimized system parameters of a technical system using a cost function, wherein the cost function is provided for the purpose of determining optimized system parameters of the technical system, wherein the technical system has different components that may be adjusted by the system parameters, and wherein, when the system parameters are set, the technical system generates different output values for the different components, including the steps of:
providing historical system parameters and the corresponding historical output values for the individual components,
providing a plurality of rules on which the technical system is based and which are based on the different system parameters and their output values,
determining a function space, wherein the function space corresponds to a set of functions in which the cost function lies,
generating a plurality of probability functions based on the historical system parameters and corresponding output values using one or more rules, wherein each of the probability functions indicates the probability with which the underlying rule is satisfied by any cost function from the function space,
combining all probability functions in order to determine the cost function by maximizing the overall probability of all rules,
optimizing the system parameters given the cost function, and
outputting the optimized system parameters in order to adjust the components of the technical system.

It was recognized that in many (engineering) areas no automated methods are yet used to determine the optimal system parameters of a technical system.

Accordingly, the computer-implemented method is not based on a predefined cost function, but rather on a multiplicity of rules that should be complied with by the cost function and a direct use of historical system parameters and output values. The technical system is based on these rules.

Such rules may be based on experience and the different historical system parameters and may form the operational basis of the system. An expert's expectations of the behavior of the technical system may be defined with the aid of the rules. For example, the rules may specify limit values for the machine parameters/machine settings which should be complied with by the machine/the technical system during its adjustment (operation) (e.g. as minimum and maximum system parameters to avoid overload or malfunctions) or output values that should be complied with by the technical system in the different operating modes. The individual rules may also be dependent on each other. The rules may be specified, for example, in a preference representation form, ordinal and/or numerical representation form depending on the system parameters.

Furthermore, a function space in which the desired cost function lies is determined.

A function space is a set of functions that all have the same definition range. Usually this is infinitely dimensional.

Furthermore, the rules determined above are translated as probability functions which are based on historical system parameters and output values and determine the observed probability with which the rules are satisfied by any cost function from the function space.

The rules may preferably, but not necessarily, always each be translated as a pairwise probability function. This means that the existing rules are translated into pairwise probability functions. In this case, pairs of historical examples are formed for which the rule applies. The probability may be designed, for example, as a sigmoid function.

For example, a rule stating that the output values x are better than the output values y results in the probability function.

$$p = sigmoid ( x - y )$$

The cost function results from the resulting determined probability functions. The cost function is now optimized with the aid of an optimization method, for example one that supports multi-modal solution spaces, whereby that function from the function space which maximizes the overall probability of all rules or the probability that all rules are complied with is determined.

To evaluate the cost function, historical output values are used to compare the resulting quality of the cost function with the expert opinion.

The computer-implemented method may be used to determine system parameters without human experimentation, which ensure a high level of quality.

The computer-implemented method allows expert knowledge to be reproduced in an understandable notation.

Furthermore, the computer-implemented method allows changes in the requirements and any resulting correlation effects to be easily taken into account. Manual consideration of the changes and their correlation effects by an expert is not necessary.

In addition, the computer-implemented method implicitly guarantees the validity of the cost function, as historical output values/system parameters are used for determination. Furthermore, the quality of the system parameters may be explicitly determined and justified using the computer-implemented method.

Contradictions between historical output values and expert knowledge may be explicitly represented using the computer-implemented method.

According to one embodiment variant, it is possible for the technical system to be represented or simulated virtually as a simulation. This makes it possible to more easily determine and, above all, validate the optimized system parameters than when using the real technical system to validate determined optimized system parameters.

In one embodiment, a probability function is respectively generated based on one rule. The rules may be preferably dependent on each other or build on one another. The rules may also be specified, for example, by customer requirements or boundary conditions.

According to one embodiment, the technical system is a physical system in which the system behavior (or components of the technical system) may be changed by freely-adjustable parameters (manipulated variables). This means that certain manipulated variables (of the components of the technical system) may be changed mechanically, electrically or digitally, as a result of which measurable properties of the system change. This raises the problem of optimal manipulated variables in relation to the measurable properties.

As an embodiment variant, it is possible for the physical system to be represented virtually as a simulation, which simplifies changing the manipulated variables and measuring the properties.

One embodiment relates to the determination of optimal parameters for operating a control unit (an ECU, electronic control unit), for example in a vehicle.

In a further embodiment, the function space is represented as a model using an expert system. The function space, which is usually infinitely dimensional, may be restricted. The expert system may independently limit or reduce the function space based on acquired expert knowledge.

In a further embodiment, the function space is represented by a model from the machine learning method. This means that the function space may also be reduced. The functions common in machine learning such as kernel functions or neural networks may be used here.

In a further embodiment, the rules provided are weighted. The more important rules are given a higher weighting than less important rules.

Furthermore, the rules may be determined using an expert system. This may be done automatically, for example. The individual output values may also be weighted.

This allows better system parameters to be found by means of an improved cost function.

Furthermore, the object is addressed by a computer system which is configured to determine optimized system parameters of a technical system using a cost function. The cost function is provided for the purpose of determining optimized system parameters of the technical system. The technical system has different components that may be adjusted by the system parameters and, when the system parameters are set, the technical system generates different output values for the different components.

The computer system has a memory unit with historical system parameters and corresponding historical output values for the individual components. A plurality of rules on which the technical system is based and which are based on the different system parameters are stored in the memory unit.

The computer system has a processor that is designed to determine a function space. The function space corresponds to a set of functions in which the cost function lies. The processor is designed to generate a plurality of probability functions based on the historical system parameters and corresponding output values using one or more rules. Each of the probability functions indicates the probability with which the underlying rule is satisfied by any cost function from the function space.

The computer system also has an optimization unit, wherein the optimization unit is designed to combine all probability functions in order to determine the cost function by maximizing the overall probability of all rules. The optimization unit is further designed to optimize the system parameters given the cost function.

The computer system finally has an output unit which is designed to the optimized system parameters in order to adjust the components of the technical system.

The advantages of the method may also be applied to the computer system.

An expert system is provided in a further embodiment, wherein the function space may be modeled using the expert system.

In a further embodiment, a machine learning method is provided, wherein the machine learning method is designed to model the function space.

Furthermore, it is possible to provide an expert system which is designed to determine/model the rules.

### BRIEF DESCRIPTION OF THE DRAWINGS

Example embodiments of the present disclosure are explained in more detail below with reference to the accompanying drawings, in which:

FIG. 1: schematically shows the method, and

FIG. 2: schematically shows the method using a closing system.

### DETAILED DESCRIPTION

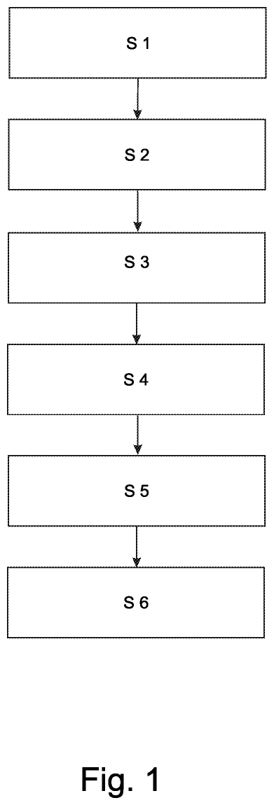

FIG. 1 schematically shows the method for determining a cost function. The cost function is provided for the purpose of determining optimized system parameters of a technical system.

The technical system has different components that may be adjusted by the system parameters. When the system parameters are set, the technical system generates different output values for the different components.

Such a technical system includes all systems that have parameterization problems. Parameterization problems are problems in which a technical system has freely-selectable system parameters that influence the system behavior, whereby the system behavior is subject to evaluation. In such a technical system, the system parameters represent free variables that are optimized using a cost function (evaluation function). This cost function describes the quality of the system and is evaluated by testing the effect of the system parameters using the system. The output of the system then forms the input of the cost function.

An environment for such parameterization problems is, for example, automatic closing systems for tailgates, (sliding) doors, windows or sliding roofs, drive units and injection systems, transmission systems, exhaust gas regulation systems, manufacturing and production processes, circuit boards, temperature protection systems, etc.

In a first step S1, historical system parameters and the corresponding historical output values for the individual components are generated and evaluated. These may have been found to be good by an expert, for example.

In a second step S2, a rule set based on the different system parameters and historical system parameters is determined. This may be based on experience or customer requirements or simply reflect system limits or good operating conditions.

Examples of such rules are:
the output values of an analysis A or a test A are better than the output values of an analysis B or test B,
a specific system parameter or output value should be small or large or within a range of values,
the output values of an analysis or test A should have a certain value on an ordinal scale or nominal scale,
the system parameters or output values in a certain range should have a predefined value on an ordinal scale, and
the output values of an analysis or test A should have a predefined quality value.

The rules may be defined in an ordinal form of representation and/or nominal form of representation and/or as preferences.

Furthermore, in a third step S3, a function space is determined, wherein the function space corresponds to a set of functions in which the desired cost function lies. The function space is usually infinitely dimensional. To reduce this, common functions in machine learning such as kernel functions or artificial neural networks may be used, with which the function space may be modeled. An expert system may also be provided, wherein the function space may be represented using the expert system.

In a fourth step S4, a plurality of pairwise probability functions based on the historical output values are generated using two rules, wherein each of the pairwise probability functions indicates the probability with which the rules are satisfied. This means that the existing rules are translated into pairwise probability functions. In this case, pairs of historical examples are formed for which the rule applies.

Not only pairwise probability functions may be formed, but also probability functions that satisfy one or more rules. The rules are thus translated as a probability function which defines, based on historical output values, the observed probability with which the applied rules are satisfied.

In a fifth step S5, all probability functions are combined in order to determine the cost function by increasing and maximizing the overall probability of all rules. The system parameters are then optimized and updated given the cost function.

This may be done with the aid of an optimization method that supports multi-modal solution spaces. This makes it possible to choose that function from the function space which maximizes the overall probability of all rules.

In a sixth step S6, the optimized, updated system parameters obtained from step S5 are output in order to adjust the components of the technical system.

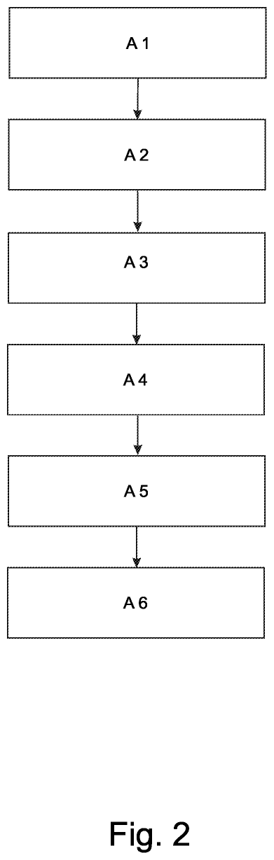

FIG. 2 describes the computer-implemented method using the example of a closing system for vehicles.

In the field of electrical closing systems for vehicles, such as tailgates, doors or window regulators, parameterizable systems are responsible for detecting whether an object/person is trapped and therefore the closing process must be aborted. These closing systems not only influence entrapment detection, however, but also the closing behavior itself. In addition, the closing behavior may be subject to explicit requirements of the vehicle manufacturer.

In a first step A1, historical system parameters and the corresponding historical output values for the individual components are generated and evaluated. These system parameters may be evaluated, for example, by an expert.

In a second step A2, a rule set is created. This may be based on preferences, ordinal ratings and numerical ratings of the historical and non-historical system parameters. Furthermore, empirical values or operating parameters (from the manufacturer) or customer requirements may be formulated as a rule. Examples include:
1. The number of undetected entrapments should be minimized,
2. The number of incorrectly detected entrapments should be minimized,
3. The maximum closing force must have a certain value and should be minimized,
4. The final parameters from the historical data may be considered good.

The rules are also weighted in order to indicate that not all rules are equally relevant. For example, rule 1 is given a higher rating than all others.

In a third step A3, a function space of the cost function is determined. This is an infinite set of functions determined by their function parameters.

For example, one of the rules here is that the maximum closing force must always be above a certain value. Therefore, this part of the cost function may be determined using a limit value function G_{γ}, for which, however, it has not yet been determined how quickly the costs will increase if the limit value is exceeded.

The evaluation of undetected and incorrectly detected entrapments, however, is comparable to a binary classification. Therefore, common evaluation mechanisms such as the F-beta score F_{β} may be used for this, but the beta value is not known.

In addition, it is determined how the two parts of the cost function relate to each other.

To determine the cost function c with different function parameters:

$$c = {α}_{1} * {F}_{β} + {α}_{2} * {G}_{γ}$$

the method determines the gradient value γ of the limit value function G, the β factor and the weighting α₁, α₂ of the two terms.

In a fourth step A4, a plurality of pairwise probability functions are generated using two rules. Rules 1 to 3 are translated into pairwise probability functions. In this case, pairs of historical examples are formed for which the rule applies.

In this case, the probability may be defined as a sigmoid function of the cost difference. A sigmoid function is a mathematical function with an S-shaped graph.

For example, the system parameter(s) x with the corresponding evaluation parameters has/have a lower maximum closing force than y. This results in the probability function:

$$p = sigmoid ( x - y ) .$$

Rule 4 may be represented using a variable normal distribution. This means that all historical final system parameters x are given a probability function:

$$p = N ( 0 , σ ) * p d f ( x )$$

where N is the normal distribution, 0 stands for a “good” cost value, σ describes the variance as a free variable and pdf is the point probability (probability density function), which only relates to the system parameter x.

The probability functions each indicates the correctness of the rule set in relation to the system parameters of the cost function.

In a fifth step A5, the final probability function is determined. This is the product of all probability functions derived from the rules.

The result of the fifth step A5 is now a function that defines the probability of the correctness of the cost function depending on the free parameters γ, β, α₁, α₂, σ.

In a sixth step A6, the cost function is optimized and updated. For this purpose, it is possible to use multi-modal optimization methods that determine these system parameters in such a way that the probability is maximized (increased) and thus fully defines the cost function. Examples of this may be the Hamiltonian Monte Carlo method (hybrid Monte Carlo algorithm) or the maximum likelihood estimation method.

Furthermore, Markov chains, generic algorithms, “simulated annealing” methods or other suitable methods may also be used.

### LIST OF REFERENCE SIGNS

S1-6, A1-6 Method steps

1. A computer-implemented method for determining updated system parameters of a technical system using a cost function, the method comprising:
providing a cost function for the purpose of determining updated system parameters of the technical system, wherein the technical system has different components that are adjustable by the system parameters, and wherein, when the system parameters are set, the technical system generates different output values for the different components:
receiving, by a processor from memory, historical system parameters and corresponding historical output values for the individual ones of the different components,
receiving, by the processor from the memory, a plurality of rules on which the technical system is based and which are based on the different system parameters and their output values,
determining, by the processor, a function space, wherein the function space corresponds to a set of functions in which the cost function lies,
generating, by the processor, a plurality of probability functions based on the historical system parameters and corresponding historical output values using one or more rules, wherein each of the probability functions indicates the probability with which the rule is satisfied by any cost function from the function space,
combining, by a computer system of which the processor and the memory are a part, all probability functions in order to determine the cost function by maximizing increasing overall probability of all rules,
updating, by the computer system, the system parameters given the cost function, and
outputting, by the computer system, the updated system parameters in order to adjust the different components of the technical system.

2. The computer-implemented method as claimed in claim 1, wherein a probability function is generated by the processor based on one rule of the plurality of rules.

3. The computer-implemented method as claimed in claim 1, wherein the technical system is a physical system in which the system behavior may be changed using freely adjustable system parameters of the plurality of system parameters.

4. The computer-implemented method as claimed in claim 3, wherein certain manipulated variables of the different components are mechanically, electrically or digitally alterable using the freely adjustable parameters.

5. The computer-implemented method as claimed in claim 1, wherein the rules are weighted.

6. The computer-implemented method as claimed in claim 1, wherein the rules are determined using an expert system.

7. The computer-implemented method as claimed in claim 1, wherein different output values are weighted.

8. A computer system configured to determine updated system parameters of a technical system using a cost function, wherein the cost function is provided for the purpose of determining system parameters of the technical system, wherein the technical system has different components that can be adjusted by the system parameters, and wherein, when the system parameters are set, the technical system generates different output values for the different components,
the computer system comprising:
memory with historical system parameters and the corresponding historical output values for the individual components, wherein a plurality of rules on which the technical system is based and which are based on the different system parameters are stored in the memory, and
a processor, wherein the processor is configured to determine a function space, wherein the function space corresponds to a set of functions in which the cost function lies, and the processor is further configured to generate a plurality of probability functions based on the historical system parameters and corresponding output values using one or more rules, wherein each of the probability functions indicates a probability with which the rule is satisfied by any cost function from the function space,
wherein the computer system is configured to combine all probability functions in order to determine the cost function by increasing the overall probability of all rules and to update the system parameters given the cost function, and
wherein the computer system outputs the updated system parameters in order to adjust the components of the technical system.

9. The computer system as claimed in claim 8, wherein an expert system is provided and the expert system is configured to determine the rules.
